(19) United States
(12) Patent Application Publication
(10) Pub. No.: US 2026/0151920 A1
(43) Pub. Date: Jun. 4, 2026

(54) FINGER MODULE, MECHANICAL HAND, AND ROBOT

(71) Applicants: ZHEJIANG QIANGNAO TECHNOLOGY CO., LTD., HANGZHOU (CN); SHENZHEN MENTAL FLOW TECHNOLOGY CO.,LTD., SHENZHEN (CN)

(72) Inventors: BICHENG HAN, HANGZHOU (CN); WENGUANG WANG, HANGZHOU (CN); DISI A, HANGZHOU (CN); ZHAN LU, HANGZHOU (CN); YIQIAN GAO, HANGZHOU (CN); JUNHAN LI, HANGZHOU (CN)

(21) Appl. No.: 19/369,339

(22) Filed: Oct. 27, 2025

(30) Foreign Application Priority Data
Dec. 3, 2024 (CN) 202411754946.7

(51) Int. Cl. B25J 15/00

(52) U.S. Cl. CPC B25J 15/0009

(57) ABSTRACT

The disclosure provides a finger module, a mechanical hand, and a robot. The finger module includes a finger base; a knuckle assembly rotatably connected with the finger base; a driving assembly including a driving member, a worm and a worm wheel, the driving member being arranged on the finger base, the worm being arranged within the finger base and connected with an output shaft of the driving member, and the worm wheel being meshed with the worm wheel; and a connecting rod member with one end being in transmission connection with the worm wheel and the other end being in transmission connection with the knuckle assembly. The driving member is configured to drive the worm to rotate, and drive the connecting rod member to rotate through the worm wheel so as to drive the knuckle assembly to rotate relative to the finger base.

### TECHNICAL FIELD

The disclosure relates to the technical field of mechanical hands, in particular to a finger module, a mechanical hand, and a robot.

### BACKGROUND

Mechanical hands are often used to replace human hands for grasping, manipulating, and other operations, and have characteristics of being accurate and flexible. As an important part of a humanoid hand, their finger modules can achieve flexion and extension functions similar to those of human fingers.

Finger modules of mechanical hands in related art have a problem of insufficient control accuracy, which cannot completely simulate complex movement of human fingers, resulting in that the mechanical hands cannot accurately adjust positions and angles of fingers in some specific actions or postures, which affects grasping effect and operation accuracy.

### SUMMARY

A main object of the disclosure is to provide a finger module, a mechanical hand, and a robot, aiming at solving a technical problem that finger modules in related art can not accurately adjust positions and angles of fingers.

In order to achieve the above object, the disclosure provides a finger module for a mechanical hand, which includes:
a finger base;
a knuckle assembly rotatably connected with the finger base;
a driving assembly comprising a driving member, a worm and a worm wheel, the driving member being arranged on the finger base and provided with an output shaft extending into the finger base, the worm being arranged within the finger base and connected with the output shaft, and the worm wheel being meshed with the worm wheel; and
a connecting rod member with one end being in transmission connection with the worm wheel and the other end being in transmission connection with the knuckle assembly.

The driving member is configured to drive the worm to rotate, and drive the connecting rod member to rotate through the worm wheel, so as to drive the knuckle assembly to rotate relative to the finger base.

In some embodiments, the output shaft of the driving member is arranged along a first direction, the worm and worm wheels are arranged along a second direction, and the second direction is perpendicular to the first direction.

A first mounting cavity and a second mounting cavity which are communicated along the second direction are provided within the finger base, the first mounting cavity is configured to receive the output shaft and the worm, and the second mounting cavity is configured to receive the worm wheel.

In some embodiments, the finger base is provided with a through hole and a mounting groove along the first direction and both are communicated with the first mounting cavity, the through hole is arranged facing to and spaced apart from the mounting groove, the through hole is configured for the output shaft to penetrate into the first mounting cavity, and the mounting groove is configured to accommodate a free end of the output shaft.

In some embodiments, the finger base is provided with a limiting groove which is communicated with the second mounting cavity and configured to avoid rotation of the connecting rod member, and both side walls of the limiting groove located on a rotation track of the connecting rod member are each provided with a limiting end face for limiting a rotation range of the connecting rod member.

In some embodiments, a friction ring is respectively provided between the worm and the mounting groove, and between the worm and the through hole.

In some embodiments, a partition groove is provided at an end of the connecting rod member away from the knuckle assembly, and a mounting hole is respectively defined in each one of two facing sides of the partition groove.

The worm wheel is rotatably connected in the second mounting cavity through a first rotating shaft and is installed in the partition groove, the first rotating shaft passes through the worm wheel, and both ends of the first rotating shaft are installed in the respective mounting holes.

In some embodiments, the knuckle assembly includes a first knuckle and a second knuckle. The first knuckle is rotatably connected with the finger base, the second knuckle is rotatably connected with the first knuckle, the first knuckle is hollow, and the connecting rod member passes through the first knuckle, with one end being in transmission connection with the worm wheel and the other end being connected with the second knuckle.

In some embodiments, the connecting rod member includes a first rod segment and a second rod segment which are connected with each other. A length of the first rod segment is larger than a length of the second rod segment, a preset included angle is formed between the first rod segment and the second rod segment, an end of the first rod segment away from the second rod segment is in transmission connection with the worm wheel, and an end of the second rod segment away from the first rod segment is connected with the second knuckle.

A mechanical hand is further provided in the disclosure, which includes a palm module and at least one finger module as described above, and the at least one finger module is connected with the palm module.

A robot is further provided in the disclosure, which includes the mechanical hand described above.

In the present disclosure, the driving assembly is composed of the driving member, the worm, and the worm wheel. Leveraging the high gear ratio characteristics of the worm wheel and worm transmission, it amplifies the relatively small torque originally generated by the driving member, providing a powerful driving force for rotation of the knuckle assembly. Moreover, power generated by the driving assembly is transmitted to the connecting rod member through the worm wheel and the worm, and under action of the power, the connecting rod member can rotate, thereby driving the knuckle assembly to rotate relative to the finger base, simulating flexion and extension movements of human finger joints, enabling the finger module to perform actions such as bending and stretching, thus accomplishing various grasping and manipulation tasks.

### BRIEF DESCRIPTION OF THE DRAWINGS

FIG. 1 is a schematic structural view of a finger module according to an embodiment of the disclosure;

FIG. 2 is a schematic disassembled view of the finger module in FIG. 1;

FIG. 3 is a schematic sectional view of the finger module in FIG. 1;

FIG. 4 is a schematic sectional view of a finger base according to an embodiment of the disclosure;

FIG. 5 is a schematic structural view of a finger base according to an embodiment of the disclosure;

FIG. 6 is a schematic structural view of a connecting rod member according to an embodiment of the disclosure;

FIG. 7 is a schematic structural view of a mechanical hand according to an embodiment of the disclosure; and

FIG. 8 is a schematic structural view of a robot according to an embodiment of the disclosure.

Reference numbers are illustrated as follows:

100—Finger Module, 10—Finger Base, 20—knuckle Assembly, 30—Driving Assembly, 31—Driving Member, 32—Worm, 33—Worm Wheel, 311—Output Shaft, 40—Connecting Rod Member, 11—First Mounting Cavity, 12—Second Mounting Cavity, 13—Through Hole, 14—Mounting groove, 15—Limiting Groove, 16—Limiting End Face, 34—Friction Ring, 41—Partition Groove, 42—Mounting Hole, 43—First Rotating Shaft, 21—First knuckle, 22—Second knuckle, 401—First Rod Segment, 402—Second Rod Segment, 200—Mechanical Hand, 201—Palm Module, 300—Robot.

Realization of the objects, functional characteristics and advantages of the disclosure will be further explained in combination with embodiments and with reference to attached figures.

### DETAILED DESCRIPTION OF THE EMBODIMENTS

In the following, the scheme in the embodiment of the disclosure will be described clearly and completely in connection with the drawings. Obviously, the described embodiment is intended to be only a part of the embodiments of the disclosure, but not all of them. On a basis of the embodiments in this disclosure, all other embodiments obtained by the ordinary skilled in the art without any creative effort are within the protection scope of this disclosure.

It should be noted that all of directional indications (such as up, down, left, right, front, back, etc.) in the embodiments of the disclosure are only used to illustrate relative position relationships and movement conditions among respective components in a certain posture (as shown). If the certain posture changes, the directional indications vary accordingly.

It should also be noted that when an element is referred to be “fixed” or “provided” on another element, it may be directly on the another element or an intervening element may exist at the same time. When an element is referred to be “connected” to another element, it may be directly connected to the another element or an intervening element may exist at the same time.

In addition, descriptions involving “first”, “second” or the like in this disclosure are only intended for descriptive purposes, and cannot be understood as indicating or implying a relative importance, or implicitly indicating a number of the indicated technical features. Therefore, the features defined with “first” and “second” can explicitly or implicitly include at least one such feature. In addition, technical schemes of respective embodiments can be combined with each other, which must be based on enabling of realization by an ordinary skilled in the art. If the combination of technical schemes is contradictory or impossible to be realized, it should be considered that such combination of technical schemes does not exist and is not within the protection scope claimed by this disclosure.

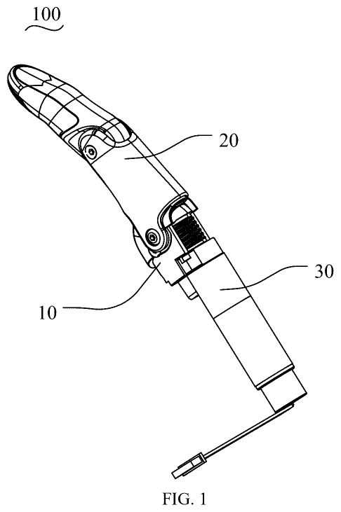

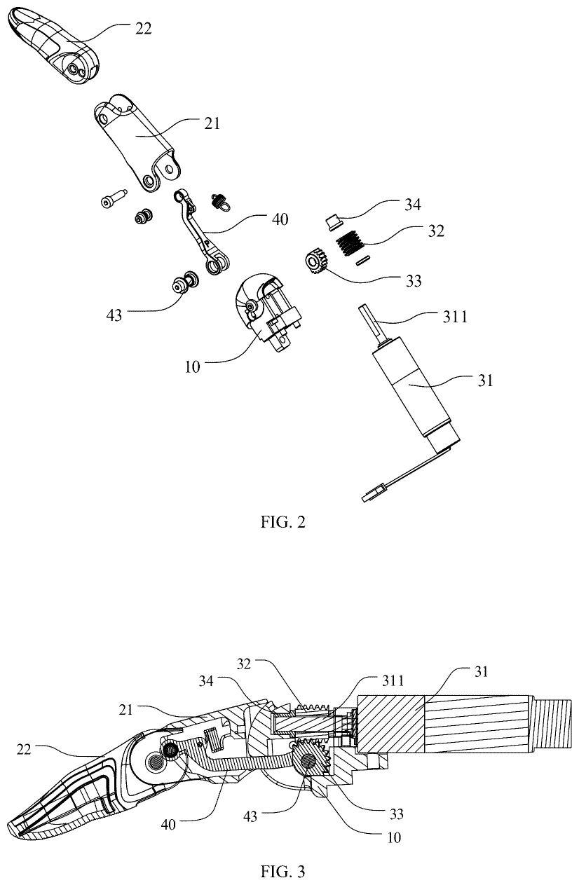

Referring to FIGS. 1 to 3, a finger module 100 for a mechanical hand is provided in an embodiment of the disclosure. The finger module 100 includes a finger base 10, a knuckle assembly 20, a driving assembly 30, and a connecting rod member 40. The knuckle assembly 20 is rotatably connected with the finger base 10. The driving assembly 30 includes a driving member 31, a worm 32, and a worm wheel 33. The driving member 31 is arranged on the finger base 10 and has an output shaft 311 extending into the finger base 10. The worm 32 is arranged within the finger base 10 and connected with the output shaft 311. The worm wheel 33 is meshed with the worm 32. One end of the connecting rod member 40 is in transmission connection with the worm wheel 33, and the other end of the connecting rod member 40 is in transmission connection with the knuckle assembly 20.

The driving member 31 is configured to drive the worm 32 to rotate, and drive the connecting rod member 40 to rotate through the worm wheel 33, so as to drive the knuckle assembly 20 to rotate relative to the finger base 10.

In this embodiment, as an initial power source of the whole driving assembly 30, the driving member 31 is installed on the finger base 10, and its output shaft 311 extending into the finger base 10 can output power. When the driving member 31 starts to operate (for example, the motor is energized to rotate), the output shaft 311 starts to rotate. Because the worm 32 is connected with the output shaft 311 and the worm wheel 33 is meshed with the worm 32, the worm 32 can rotate synchronously with the output shaft 311, and the worm 32 can drive the worm wheel 33 to rotate by virtue of its spiral teeth. The worm wheel 33 is in transmission connection with an end of the connecting rod member 40, and thus rotating motion of the worm wheel 33 is transmitted to the connecting rod member 40. After the power transmitted by the worm wheel 33 is received, the knuckle assembly 20 is driven to rotate relative to the finger base 10, so as to realize flexion and extension of the whole finger module 100 like a human hand, and accomplish functions such as grasping and manipulating objects.

Further, the embodiment adopts the transmission mechanism of the worm 32 and the worm wheel 33, which achieves a high transmission ratio. This converts a relatively high rotational speed of the output shaft 311 of the driving member 31 into a lower rotational speed at the worm wheel 33 end while simultaneously amplifying the torque. In this way, when the finger module 100 is driven, even if a torque output by the driving member 31 is limited, a sufficient large torque can be provided to the connecting rod member 40 after transmission by the worm wheel and the worm 32. This ensures powerful rotation of the knuckle assembly 20, meeting force requirements of the finger module 100 during operation such as grasping objects. The advantage is especially evident when grasping heavier objects or those requiring greater clamping force.

Due to a clear and definite power transmission link, the process of movement transmission from the driving member 31 to the knuckle assembly 20 involves fixed and easily controllable connection relationships among respective components. By accurately controlling moving parameters of the driving member 31, such as a rotation speed and steering of the output shaft 311, a moving state of the knuckle assembly 20 including its rotation angle and speed can be accurately regulated. Moreover, rotation connection between the knuckle assembly 20 and the finger base 10, combined with the transmission function of the connecting rod member 40, enables flexible movement of the knuckle assembly 20. This flexibility enables the finger module 100 to simulate various actions of human fingers such as bending, extending, grasping and the like according to different operation requirements. It also enables adaptation to objects of varying shapes and sizes to a certain extent, thus improving universality and adaptability of the mechanical hand.

It should be understood that the driving member 31 may take various forms. For instance, it may be a small motor capable of converting electric energy into mechanical energy and drive the connecting rod member 40 through rotation of the output shaft 311. Alternatively, the driving assembly may be a pneumatic or hydraulic device that utilizes a pressure generated by compressed gas or liquid to actuate components such as a piston and other components to move, which in turn drives the connecting rod member 40 to realize rotation of the knuckle assembly 20. These different types of driving members 31 can be selected according to specific application scenarios to meet requirements of flexible and stable operation of the finger module 100 under various operation conditions.

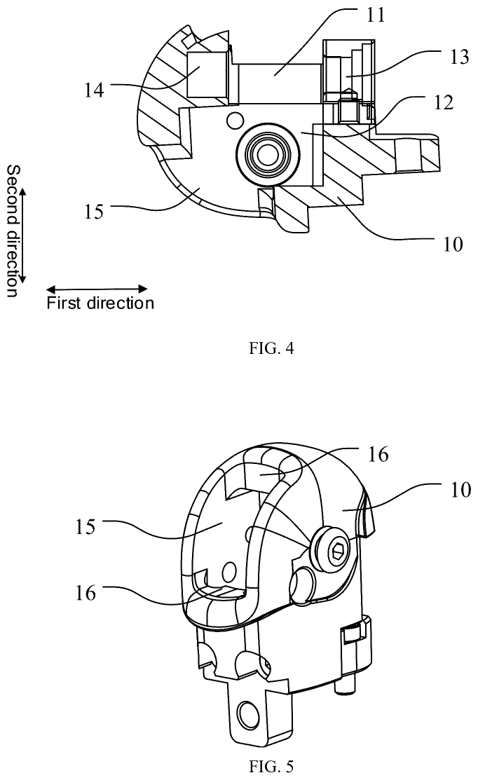

Referring to FIGS. 3 and 4, the output shaft 311 of the driving member 31 is arranged in a first direction, the worm 32 and the worm wheel 33 are arranged in a second direction, and the second direction is perpendicular to the first direction.

A first mounting cavity 11 and a second mounting cavity 12 which are communicated in the second direction are provided within the finger base 10. The first mounting cavity 11 is configured to receive the output shaft 311 and the worm 32, and the second mounting cavity 12 is configured to receive the worm wheel 33.

The output shaft 311 of the driving member 31 is arranged along the first direction, while the worm 32 and the worm wheel 33 are arranged along the second direction perpendicular to the first direction. This configuration allows effective directional change during power transmission, converting axial movement of the output shaft 311 to rotational movement in a plane where the worm 32 and the worm wheel 33 are located, such that the space can be reasonably utilized and a transmission relationship among the components can be adapted. For example, the output shaft 311 outputs power in a horizontal direction (assumed as the first direction), and the vertically arranged worm 32 and worm wheel 33 (the second direction) converting the transmission, thus avoiding space waste or structural interference caused by excessive extension of the respective components in a same direction.

The first mounting cavity 11 and the second mounting cavity 12 communicated in the second direction are provided within the finger base 10, which are respectively configured to accommodate the output shaft 311, the worm 32 and the worm wheel 33, to provide accurate and stable mounting positions for the respective components. The first mounting cavity 11 accommodates the output shaft 311 and the worm 32, ensuring their close connection in a same space and and a smooth power transmission from the output shaft 311 to the worm 32. The second mounting cavity 12 is configured to accommodate the worm wheel 33, allowing a proper position for the worm wheel 33 to mesh with the worm 32. The worm wheel 33 rotates stably in the second mounting cavity 12, and transmits power from the worm 32 smoothly through a communicated space structure. The whole layout creates a good physical environment for transmission of the worm wheel and the worm 32.

When the driving member 31 is activated, its output shaft 311 arranged in the first direction starts to rotate. Because the output shaft 311 is connected with the worm 32 in the first mounting cavity 11, power is directly transmitted to the worm 32, causing the worm 32 to rotate in the second direction. During this process, structure of the first mounting cavity 11 limits relative position and connection stability of the output shaft 311 and the worm 32, thereby guaranteeing reliability of power transmission. The worm 32 rotating in the second direction is meshed with the worm wheel 33 located in the second mounting cavity 12, and the worm 32 drives the worm wheel 33 to rotate according to a transmission principle of the worm and the worm wheel.

In this embodiment, the interconnected design of the first mounting cavity 11 and the second mounting cavity 12 ensures that a meshing state between the worm 32 and the worm wheel 33 remains optimal and stable, preventing transmission issues such as tooth disengagement or jamming due to unreasonable spatial structure, thus guaranteeing continuous and smooth power transmission from the worm 32 to the worm wheel 33. The power is then transmitted through the subsequent connecting rod member 40 to drive the knuckle assembly 20 to move, so as to realize functions of the finger module 100.

Further, in this embodiment, the output shaft 311 of the driving member 31 and respective the worm 32 and the worm wheel 33 are arranged in mutually perpendicular directions, and by utilizing interconnected installation cavities within the finger base 10 that extend along their corresponding directions, the space utilization in the finger base 10 is greatly improved. This configuration allows all components to be housed in a compact and organized manner within a limited space, which avoids space waste caused by random component layout or extension in same direction of the components. Such an arrangement contributes to miniaturization and weight reduction of the mechanical hand.

In some embodiments, the finger base 10 is provided with a through hole 13 and a mounting groove 14 both communicated with the first mounting cavity 11 along the first direction. The through hole 13 is arranged facing to and spaced apart from the mounting groove 14, the through hole 13 is configured for the output shaft 311 to penetrate into the first mounting cavity 11, and the mounting groove 14 is configured to accommodate a free end of the output shaft 311.

During the assembly of the finger module 100, the output shaft 311 can smoothly pass through the through hole 13 into the first mounting cavity 11 inside the finger base 10, ensuring a precise connection with the worm 32 installed in the first mounting cavity 11. A dimension and position of the through hole 13 are designed according to specification of the output shaft 311 and connection requirements with the worm 32, so as to ensure that the output shaft 311 can maintain correct axial alignment during installation and lay foundation for subsequent stable power transmission.

The mounting groove 14, which is arranged facing to the through hole 13, is configured to accommodate the free end of the output shaft 311. After the output shaft 311 passes through the through hole 13 and enters the first mounting cavity 11 to be connected with the worm 32, the mounting groove 14 can stably accommodate the free end of the output shaft 311 therein, so as to, on one hand, prevent the unsupported free end from wobbling during operation of the finger module 100, which could otherwise affecting stability of power transmission; and on the other hand, by positioning the free end via the mounting groove 14, to further limit a position of the output shaft 311 in the first direction. This ensures a more precise positional relationship between the whole driving member 31 and the finger base 10, so that the power can be smoothly transmitted from the driving member 31 to the worm 32 according to design requirements.

In this embodiment, the design of the through hole 13 and the mounting groove 14 enables precise installation and positioning of the output shaft 311 of the driving member 31 on the finger base 10. Specifically, the output shaft 311 passes through the through hole 13 to accurately enter the first mounting cavity 11 and engage with the worm 32, and the free end of the output shaft 311 is properly received in the mounting groove 14. This well-defined installation method avoids positional deviation of the output shaft 311 caused by manual assembly error or inaccurate component fitting, thereby improving assembly accuracy of the entire finger module 100 and creating favorable conditions for subsequent stable power transmission and accurate motion control.

Referring to FIG. 4 and FIG. 5, in some embodiments, the finger base 10 is provided with a limiting groove 15 which is communicated with the second mounting cavity 12 and configured to avoid rotation of the connecting rod member 40, and both side walls of the limiting groove 15 located on a rotation track of the connecting rod member 40 are each provided with a limiting end face 16 for limiting a rotation range of the connecting rod member 40.

The connecting rod member 40 enters the limiting groove 15 and forms a rotational connection within it, providing a relatively stable rotating space for the connecting rod member 40 inside the finger base 10. When the driving assembly 30 drives the connecting rod member 40 to rotate, the connecting rod member 40 may rotate around a connection point in the limiting groove 15. The limiting end faces 16 at both ends of the limiting groove 15 along the rotation direction of the connecting rod member 40 play a critical limiting role in constraining the motion of the connecting rod member 40. As the connecting rod member 40 rotates in one direction, it may gradually approach one of the limit end faces 16. Upon contacting this limiting end face 16, the connecting rod member 40 is prevented from further rotation in that direction due to the blocking of the limiting end face 16, thus limiting its rotational angle in that direction. Similarly, when rotating in an opposite direction, the other limiting end face 16 also plays a same limiting role. As such, it effectively limiting a rotational range of the connecting rod member 40 relative to the finger base 10.

The presence of the limiting groove 15 and the limit end faces 16enables precise control over the rotation angle of the connecting rod member 40, thereby indirectly control a rotation angle of the knuckle assembly 20 relative to the finger base 10. This improves the overall movement accuracy of the finger module 100 while effectively avoiding excessive rotation of the connecting rod member 40, thus preventing potential component damage due to excessive movement.

In some embodiments, a friction ring 34 is respectively provided between the worm 32 and the mounting groove 14, and between the worm 32 and the through hole 13.

When the driving member 31 drives the worm 32 to rotate, there may be certain damping effect on rotation of the worm 32 due to friction between the friction ring 34 and the worm 32, the mounting groove 14 or the through hole 13. This damping can prevent the worm 32 from rotating out of control due to sudden power change (such as sudden change of a rotation speed of the output shaft 311 of the driving member 31). For example, when the driving member 31 suddenly accelerates or decelerates, the friction exerted by the friction ring 34 allows a rotation speed of the worm 32 to change more gradually. This ensures a more stable power transmission process from the driving member 31 to the worm 32, then through the worm wheel 33 and the connecting rod member 40 to the knuckle assembly 20, thus enhancing the motion stability of the finger module 100.

By regulating the rotation speed and position of the worm 32, the friction ring 34 ensures more stable power transmission throughout the finger module 100, thus enhancing the movement accuracy of the finger module 100. Moreover, by cushioning impact and friction between the worm 32 and the through hole 13, and between the worm 32 and the mounting groove 14, the friction ring 34 effectively protects these components, reducing their wear degree and avoiding damage of components or out-of-control movement caused by sudden shocks. This improves reliability and adaptability of the finger module 100.

In some embodiments, a partition groove 41 is provided at an end of the connecting rod member 40 away from the knuckle assembly 20, and the connecting rod member 40 is defined with a mounting hole 42 respectively in two facing sides of the partition groove 41.

The worm wheel 33 is rotatably connected within the second mounting cavity 12 through a first rotating shaft 43, the worm wheel 33 is installed in the partition groove 41, the first rotating shaft 43 passes through the worm wheel 33 and both ends of the first rotating shaft 43 are installed in respective mounting holes 42.

The partition groove 41 provided in the first rod segment 401 provides a mounting space for the worm wheel 33 to be placed therein, which achieves tighter spatial integration between the originally relatively independent driving assembly 30 and the connecting rod member 40, thus reducing inter-component gaps and eliminating unnecessary connection structures. As such, the overall structure of the finger module 100 becomes more compact. This compact structure facilitates integration of more functional components in a limited space, or makes the finger module 100 occupy minimal space when it is installed on a mechanical hand and other apparatuses, which facilitates miniaturization design and layout optimization of the whole apparatus.

Further, the secure connection between the worm wheel 33 and the first rod segment 401, achieved through the first rotating shaft 43, ensures stability in a process of power transmission. Specifically, two ends of the first rotating shaft 43 are accurately installed in the mounting holes 42, allowing the worm wheel 33 to stably drive the first rod segment 401 to rotate during rotating, which avoids issues such as interruption of power transmission or deviation of transmission angle caused by loose connection or insecure installation. As a result, the reliability of the entire transmission link from the driving assembly 30 to knuckle rotation is guaranteed, enabling smoother and more precise movement of the finger module 100. This, in turn, contributes to improved performance of the finger module 100 in long-term operations.

In some embodiments, the knuckle assembly 20 includes a first knuckle 21 and a second knuckle 22. The first knuckle 21 is rotatably connected with the finger base 10, the second knuckle 22 is rotatably connected with the first knuckle 21, the first knuckle 21 is hollow, and the connecting rod member 40 penetrates through the first knuckle 21, with one end being in transmission connection with the worm wheel 33 and the other end being connected with the second knuckle 22.

In this embodiment, the knuckle assembly 20 is composed of the first knuckle 21 and the second knuckle 22. The first knuckle 21 is rotatably connected with the finger base 10, establishing a foundation for movement of the whole knuckle assembly 20 relative to the finger base 10. This allows the first knuckle 21 to rotate about its connection point with the finger base 10, mimicking flexion and extension movement of a joint connecting a human finger with a palm of a human hand. The second knuckle 22 is rotatably connected with the first knuckles 21, which further increases flexibility of relative movement between the knuckles. This enables the second knuckle 22 to rotate relative to the first knuckle 21, analogous to the coordinated motion of multiple joints in a human finger. Such a double-level rotational configuration constructs a basic framework that allows the finger module 100 to simulate complex finger movement of a human hand.

The first knuckle 21 is hollow, which provides a passage for the connecting rod member 40 to pass through. One end of the connecting rod member 40 is in transmission connection with the worm wheel 33 for receiving power from the driving assembly 30. The power is transmitted through the connecting rod member 40 during rotation of the worm wheel 33. Since the connecting rod member 40 passes through the first knuckle 21 and is connected with the second knuckle 22, its rotation may drive the second knuckle 22 to rotate relative to the first knuckle 21. Moreover, rotational connection between the first knuckle 21 and the finger base 10, and rotational connection between the second knuckle 22 and the first knuckle 21, enables the whole knuckle assembly 20 to achieve orderly and coherent flexion and extension movement by the driving of the connecting rod member 40, so as to convert the power from the drive assembly 30 to flexible movement of the knuckles, and finally realize functions such as grasping and manipulating of the finger module 100.

Further, the hollow design of the first knuckle 21 skillfully utilizes an internal space for the connecting rod member 40 to pass through. This eliminates the need for additional external installation space for the connecting rod member 40, thereby preventing an overall bulky structure of the finger module 100. This compact structural layout not only gives the finger module 100 a cleaner appearance, but also facilitates integrated installation of multiple finger modules 100 in a limited space of the mechanical hand. This contributes to miniaturization of the mechanical hand and optimization of its overall layout, and improves space utilization efficiency.

In some embodiments, the first knuckle 21 is pin-coupled with the finger base 10; and/or,
the connecting rod member 40 is pin-coupled with the finger base 10; and/or,
the connecting rod member 40 is pin-coupled with the second knuckle 22; and/or,
the second knuckle 22 is pin-coupled with the first knuckle 21.

In this embodiment, the pin-coupling mechanism provides flexibility for relative rotation between the respective components. It can rotate freely within a certain angle range around the pin, whether the first knuckle 21 relative to the finger base 10, or between the connecting rod member 40 and other components, or between the second knuckle 22 and the first knuckle 21. This flexibility allows the finger mechanism to simulate flexion and extension of a human hand more naturally and smoothly, allowing it to better meet requirements of grasping objects of varying shapes, sizes, and textures. For example, when grasping a spherical object, respective knuckles can conform to the object's surface through flexible rotation to achieve stable grasping.

In an assembly process of the finger module 100, the pin-coupling operation is relatively straightforward. Workers only need to align corresponding pin holes on respective components and insert a pin to complete connection, which helps improve efficiency of production and assembly while reducing assembly cost. Moreover, during subsequent use, if issues such as wear occur in a pinconnection areas needing maintenance or component replacement, disassembly and reinstallation process may be carried out easily. This facilitates maintenance of the whole finger module 100 and prolongs its service life.

In some embodiments, a connection between the first knuckle 21 and the finger base 10 forms a first connection position, a connection between the connecting rod member 40 and the finger base 10 forms a second connection position, a connection between the connecting rod member 40 and the second knuckle 22 forms a third connection position, and a connection between the second knuckle 22 and the first knuckle 21 forms a fourth connection position. The first connection position, the second connection position, the third connection position, and the fourth connection position are in a quadrilateral layout.

The quadrilateral layout plays a constraint role on positions and angles of respective components in space. Taking the first knuckle 21 and the second knuckle 22 as an example, due to the presence of the fourth connection point and being in the quadrangular layout, a range of rotation angle of the second knuckle 22 relative to the first knuckle 21 is limited by this layout. This prevents excessive rotation beyond design expectation, which ensures accuracy and stability of movement of the finger module 100.

Similarly, for the connections between the connecting rod member 40 and the finger base 10, and between the connecting rod member 40 and the second knuckle 22, the quadrilateral layout formed by the second connecting position and the third connecting position confines swing angle and displacement of the connecting rod member 40 in space within a certain range. This ensures that a movement trajectory of the whole finger module 100 becomes more predictable and better aligned with design requirements, which facilitates realization of accurate grasping of objects of different shapes. For example, when grasping a rectangular object, angles and positions of respective knuckles can be accurately adjusted within a motion range defined by the quadrilateral layout to conform to the surface of the object.

In this embodiment, the quadrilateral layout constructs a relatively stable structural framework, ensuring more orderly and stable relative movement between respective connecting positions. During repeated flexion and extension movement of the finger module 100, force transmission and movement coordination among respective components occur within this layout framework, which reduces unstable factors such as wobbling or displacement caused by uncoordinated movement. This enables more reliable execution of tasks such as grasping and manipulating, and stable motion performance especially during prolonged continuous operation, ultimately improving overall performance and service life of the finger mechanism.

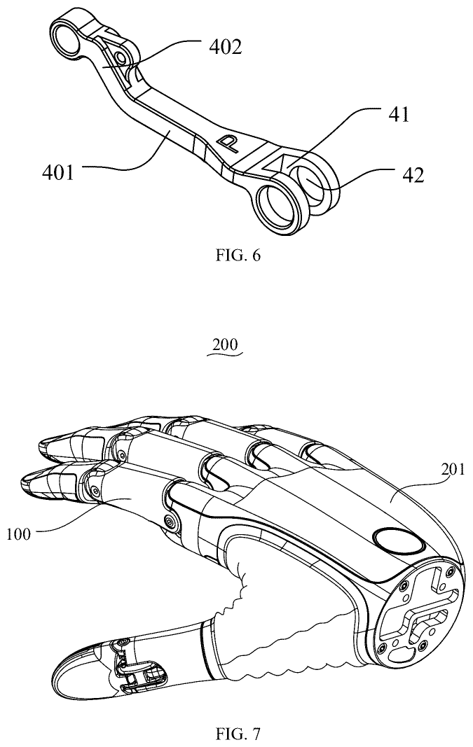

Referring to FIGS. 3 to 6, in some embodiments, the connecting rod member 40 includes a first rod segment 401 and a second rod segment 402 which are connected with each other. A length of the first rod segment 401 is larger than a length of the second rod segment 402, a preset included angle is formed between the first rod segment 401 and the second rod segment 402, an end of the first rod segment 401 away from the second rod segment 402 is in transmission connection with the worm wheel 33, and an end of the second rod segment 402 away from the first rod segment 401 is connected with the second knuckle 22.

In this embodiment, the connecting rod member 40 is composed of the first rod segment 401 and the second rod segment 402 which are connected with each other, and a preset included angle is formed between the first rod segment 401 and the second rod segment 402. This design with the included angle enables the transmission of power at specific angular relationships during motion transmission of the connecting rod member 40, altering a direction and magnitude of a force to better meet complex movement requirements of the finger module 100. Moreover, the length of the first rod segment 401 is larger than the length of the second rod segment 402, allowing for force amplification or reduction and effective angle adjustment during power transmission. According to a lever principle, when the driving assembly 30 acts on the longer end of the first rod segment 401, greater torque can be obtained at the shorter end of the second rod segment 402, thereby enhancing a gripping force of the finger module 100.

Referring to FIG. 7, a mechanical hand 200 is further provided in the disclosure, which includes a palm module 201 and at least one finger module 100 as described above, and the at least one finger module 100 is connected with the palm module 201. Since the mechanical hand 200 adopts all of technical schemes of all of the embodiments of the finger module 100, the mechanical hand 200 of the disclosure also has at least all of beneficial effects brought by the technical schemes of the above embodiments, which will not be repeated here.

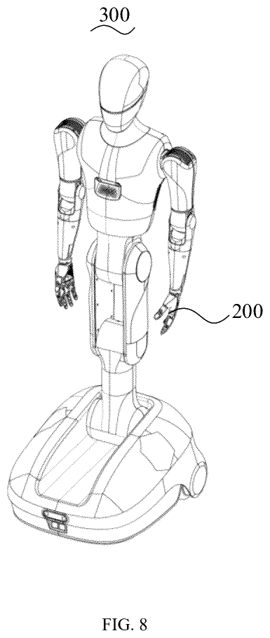

Referring to FIG. 8, a robot 300 is further provided in the disclosure, which includes the mechanical hand 200 described above. Since the robot 300 adopts all of technical schemes of all of the embodiments of the finger module 100, the robot 300 of the disclosure also has at least all of beneficial effects brought by the technical schemes of the above embodiments, which will not be repeated here.

The above embodiments are only examples for clearly explaining the disclosure, but not limitation on implementations of the disclosure. For those ordinary skilled in the art, other variations and modifications can be made based on above description. It is impossible to exhaust all of embodiments herein. All of obvious changes or variations derived from the technical schemes of the disclosure are still within the protection scope of the disclosure.

What is claimed is:

1. A finger module for a mechanical hand, comprising:
a finger base;
a knuckle assembly rotatably connected with the finger base;
a driving assembly comprising a driving member, a worm, and a worm wheel, the driving member being arranged on the finger base and provided with an output shaft extending into the finger base, the worm being arranged within the finger base and connected with the output shaft, and the worm wheel being meshed with the worm wheel; and
a connecting rod member with one end being in transmission connection with the worm wheel and the other end being in transmission connection with the knuckle assembly;
wherein the driving member is configured to drive the worm to rotate, and drive the connecting rod member to rotate through the worm wheel, so as to drive the knuckle assembly to rotate relative to the finger base;
the knuckle assembly comprises a first knuckle and a second knuckle, the first knuckle being rotatably connected with the finger base, the second knuckle being rotatably connected with the first knuckle, and the first knuckle being hollow; the connecting rod member passes through the first knuckle, with one end being in transmission connection with the worm wheel and the other end being connected with the second knuckle;
the connecting rod member comprises a first rod segment and a second rod segment which are connected with each other, a length of the first rod segment being larger than a length of the second rod segment, a preset included angle being formed between the first rod segment and the second rod segment, an end of the first rod segment away from the second rod segment being in transmission connection with the worm wheel, and an end of the second rod segment away from the first rod segment being connected with the second knuckle;
the output shaft of the driving member is arranged along a first direction, the worm and worm wheels are arranged along a second direction, and the second direction is perpendicular to the first direction;
a first mounting cavity and a second mounting cavity which are communicated along the second direction are provided within the finger base, the first mounting cavity being configured to receive the output shaft and the worm, and the second mounting cavity being configured to receive the worm wheel;
the finger base is provided with a through hole and a mounting groove along the first direction and both are communicated with the first mounting cavity, the through hole being arranged facing to and spaced apart from the mounting groove, the through hole being configured for the output shaft to penetrate into the first mounting cavity, and the mounting groove being configured to accommodate a free end of the output shaft; and
a friction ring is respectively provided between the worm and the mounting groove, and between the worm and the through hole.

2. The finger module according to claim 1, wherein the finger base is provided with a limiting groove which is communicated with the second mounting cavity and configured to avoid rotation of the connecting rod member, both side walls of the limiting groove located on a rotation track of the connecting rod member being each provided with a limiting end face for limiting a rotation range of the connecting rod member.

3. The finger module according to claim 1, wherein a partition groove is provided at an end of the connecting rod member away from the knuckle assembly, and the connecting rod member is defined with a mounting hole respectively in two facing sides of the partition groove; and
the worm wheel is rotatably connected in the second mounting cavity through a first rotating shaft and is installed in the partition groove, the first rotating shaft passes through the worm wheel, and both ends of the first rotating shaft are installed in the respective mounting holes.

4. A mechanical hand, comprising a palm module and the at least one finger module according to claim 1, the at least one finger module being connected with the palm module.

5. The mechanical hand according to claim 4, wherein the finger base is provided with a limiting groove which is communicated with the second mounting cavity and configured to avoid rotation of the connecting rod member, both side walls of the limiting groove located on a rotation track of the connecting rod member being each provided with a limiting end face for limiting a rotation range of the connecting rod member.

6. The mechanical hand according to claim 4, wherein a partition groove is provided at an end of the connecting rod member away from the knuckle assembly, and the connecting rod member is defined with a mounting hole respectively in two facing sides of the partition groove; and
the worm wheel is rotatably connected in the second mounting cavity through a first rotating shaft and is installed in the partition groove, the first rotating shaft passes through the worm wheel, and both ends of the first rotating shaft are installed in the respective mounting holes.

7. A robot, comprising the mechanical hand according to claim 4.

8. The robot according to claim 7, wherein the finger base is provided with a limiting groove which is communicated with the second mounting cavity and configured to avoid rotation of the connecting rod member, both side walls of the limiting groove located on a rotation track of the connecting rod member being each provided with a limiting end face for limiting a rotation range of the connecting rod member.

9. The robot according to claim 7, wherein a partition groove is provided at an end of the connecting rod member away from the knuckle assembly, and the connecting rod member is defined with a mounting hole respectively in two facing sides of the partition groove; and
the worm wheel is rotatably connected in the second mounting cavity through a first rotating shaft and is installed in the partition groove, the first rotating shaft passes through the worm wheel, and both ends of the first rotating shaft are installed in the respective mounting holes.
